(19) United States
(12) Patent Application Publication
(10) Pub. No.: US 2017/0344169 A1
(43) Pub. Date: Nov. 30, 2017

(54) INTEGRAL APPARATUS FOR SENSING TOUCH AND FORCE

(71) Applicant: SUPERC-TOUCH CORPORATION, New Taipei City (TW)

(72) Inventors: HSIANG-YU LEE, New Taipei City (TW); Shang CHIN, New Taipei City (TW); Ping-Tsun LIN, New Taipei City (TW)

(21) Appl. No.: 15/596,456

(22) Filed: May 16, 2017

(30) Foreign Application Priority Data
May 26, 2016 (TW) 105116420

(51) Int. Cl. G06F 3/041; G06F 3/044

(52) U.S. Cl. CPC G06F 3/0414; G06F 3/0416; G06F 3/044

(57) ABSTRACT

An integral apparatus for sensing touch and force includes a touch-control panel, a force electrode layer, a touch sensing integrated circuit, and a force sensing integrated circuit. In a touch sensing operation, a plurality of touch sensing electrodes of the touch-control panel are electrically connected to the touch sensing integrated circuit through a plurality of switch circuits in the force sensing integrated circuit to conduct the touch sensing operation. In a force sensing operation, the touch sensing electrodes are electrically connected to a capacitance sensing circuit in the force sensing integrated circuit through a plurality of switch circuits in the force sensing integrated circuit to conduct a force sensing operation.

### BACKGROUND

### Technical Field

The present invention relates to a sensing apparatus, and more particularly to an integral apparatus for sensing touch and force.

### Description of Related Art

The touch display panels become popular as the market growing of the compact and lightweight mobile device. The force touch control technology has rapid development owing to the maturity of touch-control user interface and serious demand for 3D touch operation. The conventional force touch-control panel generally integrates microelectromechanical sensor at edge or corner of the display panel to sense touch force on the display panel. The cost of the sensor is high and the assembling of the sensor is difficult. Besides, the conventional force touch-control panel uses deformable resilient microstructure formed by complicated process to get better relevance between force and deformed degree. The force sensing can be improved by augmented physical variation. However, it still needs lots of effort to improve the force touch-control panel.

### SUMMARY

It is an object of the present invention to provide an integral apparatus for touch sensing and force sensing operations to overcome above mentioned drawbacks.

Accordingly, the present invention provides an integral apparatus for sensing touch and force. The integral apparatus includes a touch-control panel, a force electrode layer, a resilient dielectric material layer, a flexible printed circuit board, a touch sensing integrated circuit, and a force sensing integrated circuit. The touch-control panel has a plurality of touch sensing electrodes, a plurality of conductive pads, and a plurality of electrode connecting wires. The force electrode layer has at least one force sensing electrode. The resilient dielectric material layer is arranged on one side of the force electrode layer. The flexible printed circuit board is electrically connected to the touch-control panel and the force electrode layer. The touch sensing integrated circuit is arranged on the flexible printed circuit board. The force sensing integrated circuit is arranged on the flexible printed circuit board, and the force sensing integrated circuit has at least one capacitance sensing circuit and a plurality of switch circuits. In a touch sensing operation, the touch sensing electrodes are electrically connected to the touch sensing integrated circuit through the switch circuits in the force sensing integrated circuit to conduct the touch sensing operation. In a force sensing operation, the touch sensing electrodes are electrically connected to the at least one capacitance sensing circuit in the force sensing integrated circuit through the plurality of switch circuits in the force sensing integrated circuit to conduct the force sensing operation.

It is to be understood that both the foregoing general description and the following detailed description are exemplary, and are intended to provide further explanation of the present invention as claimed. Other advantages and features of the present invention will be apparent from the following description, drawings and claims.

### BRIEF DESCRIPTION OF DRAWING

The present invention can be more fully understood by reading the following detailed description of the embodiment, with reference made to the accompanying drawings as follows:

FIG. 1 shows a schematic view of a touch-control apparatus.

FIG. 2 shows a schematic view of an integral apparatus for sensing touch and force according to the present invention.

FIG. 3 shows a schematic view of the integral apparatus for use in a touch sensing operation according to the present invention.

FIG. 4 shows a schematic view of the integral apparatus for use in a force sensing operation according to the present invention.

FIG. 5A is a schematic view showing signals applied in a touch sensing operation of the integral apparatus according to an embodiment of the present invention.

FIG. 5B is a schematic view showing signals applied in the touch sensing operation of the integral apparatus according to another embodiment of the present invention.

FIG. 6 shows a partial top view of electrodes of the integral apparatus according to an embodiment of the present invention.

FIG. 7A is a schematic view showing signals applied in a force sensing operation of the integral apparatus according to an embodiment of the present invention.

FIG. 7B is a partial top view showing signals applied to electrodes of the integral apparatus according to the present invention.

FIG. 8A, FIG. 8B, and FIG. 8C are schematic views showing signals applied in the force sensing operation of the integral apparatus according to different embodiments of the present invention.

FIG. 9 shows a partial top view of touch sensing electrodes of the integral apparatus according to another embodiment of the present invention.

FIG. 10A and FIG. 10B show top views of mutual-capacitance touch-control panels of the integral apparatus according to the present invention.

FIG. 11A, FIG. 11B, and FIG. 11C are schematic views showing signals applied in the force sensing operation of the integral apparatus shown in FIG. 10A.

FIG. 12 shows a circuit diagram of a self-capacitance sensing circuit according to the present invention.

### DETAILED DESCRIPTION

Reference will now be made to the drawing figures to describe the present invention in detail. It will be understood that the drawing figures and exemplified embodiments of present invention are not limited to the details thereof.

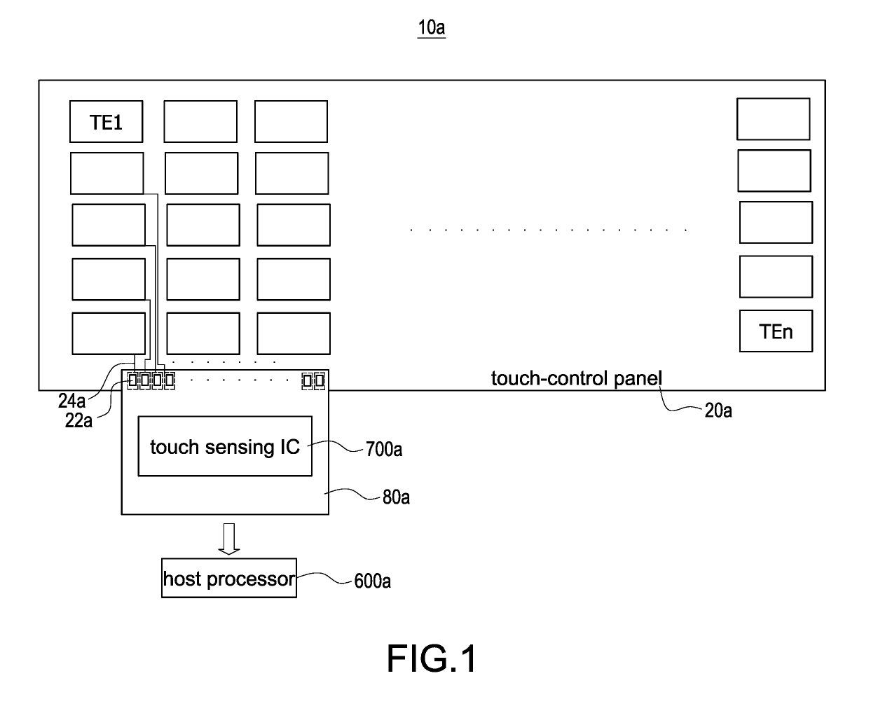

Refer to FIG. 1, which shows a schematic view of a touch-control apparatus 10a. The touch-control apparatus 10a includes a touch-control panel 20a, a flexible printed circuit board 80a, and a touch sensing integrated circuit (IC) 700a arranged on the flexible printed circuit board 80a. The flexible printed circuit board 80a of the touch-control apparatus 10a is electrically connected to a host processor 600a so that the touch-control apparatus 10a receives commands transmitted from the host processor 600a or transmits touch sensing results to the host processor 600a. The touch-control panel 20a includes a plurality of conductive pads 22a and a plurality of electrode connecting wires 24a. A plurality of touch sensing electrodes (also referred to as touch electrodes) TE1-TEn are arranged on the touch-control panel 20a and electrically connected to the corresponding electrode connecting wires 24a. The electrode connecting wires 24a are electrically connected to the flexible printed circuit board 80a through the corresponding conductive pads 22a so that touch sensing signals are transmitted to the touch sensing IC 700a for further processing.

However, the above-mentioned touch-control apparatus 10a has been not enough for use as force sensing requirements of electronic products are gradually increased. Accordingly, it is to significantly reduce time, risks, and costs of research and development (R&D) to add force sensing function by exploiting the existing touch-control apparatus 10a or touch sensing IC 700a.

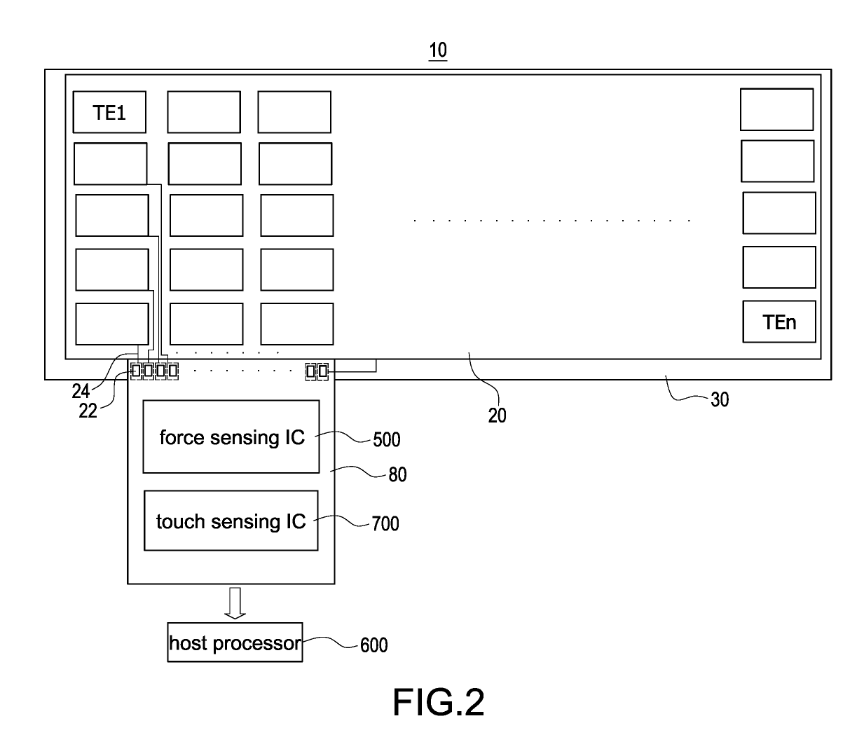

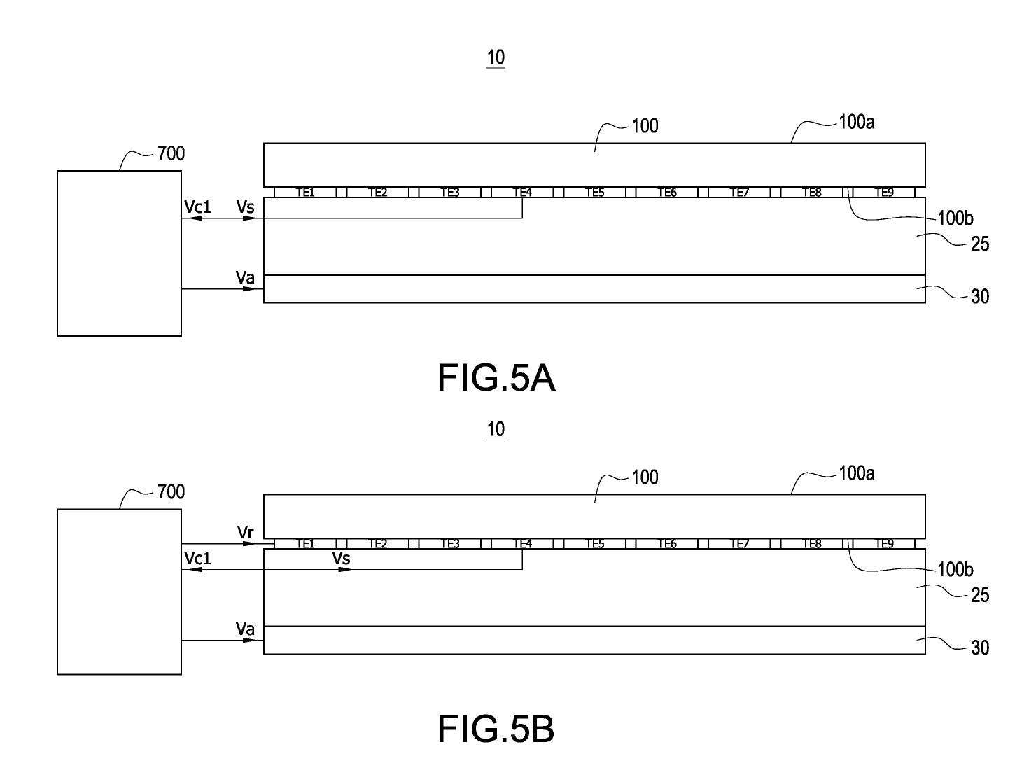

Refer to FIG. 2, which shows a schematic view of an integral apparatus for sensing touch and force (hereinafter referred to as the integral apparatus 10) according to the present invention. The integral apparatus 10 includes a touch-control panel 20, a force electrode layer 30, a flexible printed circuit board 80, a touch sensing integrated circuit 700, and a force sensing integrated circuit 500. The touch-control panel 20 and the force electrode layer 30 are electrically connected to the flexible printed circuit board 80 through a plurality of conductive pads 22 and a plurality of electrode connecting wires 24 so that the touch-control panel 20 and the force electrode layer 30 are electrically connected to the force sensing integrated circuit 500. Also refer to FIG. 5A, which is a schematic view showing signals applied in a touch sensing operation of the integral apparatus according to an embodiment of the present invention. The touch-control panel 20 includes an upper substrate 100 and a plurality of touch sensing electrodes TE1-TE9. The upper substrate 100 has a first surface 100a and a second surface 100b. The touch sensing electrodes TE1-TE9 are arranged on the second surface 100b. The integral apparatus 10 further includes a resilient dielectric material layer 25, and the resilient dielectric material layer 25 is arranged between the touch-control panel 20 and the force electrode layer 30.

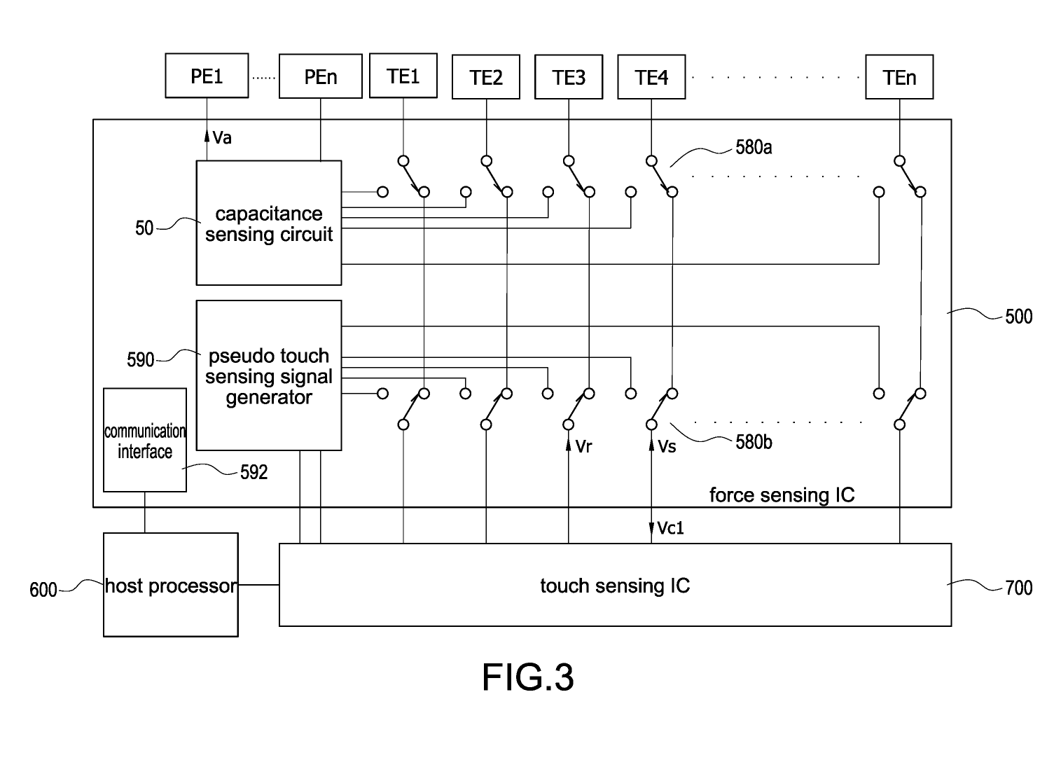

Refer to FIG. 3, which shows a schematic view of the integral apparatus 10 for use in a touch sensing operation according to the present invention. In the touch sensing operation, the touch sensing electrodes TE1-TEn are electrically connected to the touch sensing integrated circuit 700 through a plurality of switch circuits 580a, 580b in the force sensing integrated circuit 500 to conduct a touch sensing operation. With reference also to FIG. 5A, in the touch sensing operation, the touch sensing integrated circuit 700 sequentially or randomly applies a first capacitance-exciting signal Vs (also referred to as a touch capacitance-exciting signal) to a selected touch sensing electrode, such as a touch sensing electrode TE4. In addition, the touch sensing integrated circuit 700 also produces an auxiliary signal Va having the same phase as that of the first capacitance-exciting signal Vs. The auxiliary signal Va is applied to at least one corresponding force sensing electrode on the force electrode layer 30, and is described in more detail later. By applying a signal having the same phase as that of the first capacitance-exciting signal Vs on the corresponding force sensing electrode, equivalently there is minute (or even no) voltage difference between the selected touch sensing electrode TE4 and the corresponding force sensing electrode. Therefore, there is minute (or even no) capacitance between the selected touch sensing electrode TE4 and the corresponding force sensing electrode. The influence to capacitance measurement due to warp of the resilient dielectric material layer 25 can be prevented when sensing a touch operation for the selected touch sensing electrode TE4. Moreover, the influence to capacitance measurement due to parallel capacitance from the corresponding force sensing electrode and the ground point can also be prevented. Although not explicitly shown in FIG. 5A, the touch sensing integrated circuit 700 transmits the first capacitance-exciting signal Vs to the selected touch sensing electrode TE4 through the plurality of switch circuits 580a, 580b, transmits the auxiliary signal Va to at least one corresponding force sensing electrode, and receives a touch sensing signal Vc1 generated from the selected touch sensing electrode TE4.

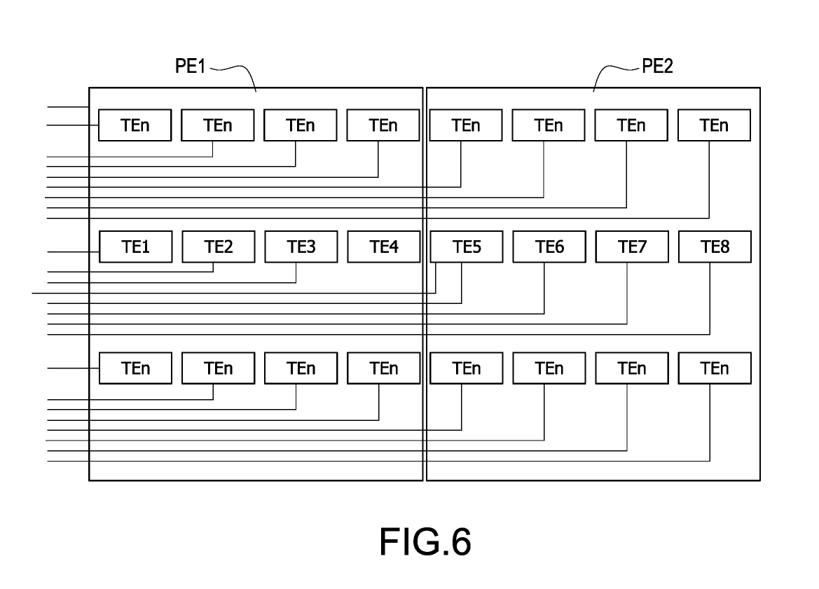

Refer to FIG. 6, which shows a partial top view of touch sensing electrodes of the integral apparatus 10 according to an embodiment of the present invention, which mainly depicts the distribution of the touch sensing electrodes TE1-TE8, TEn and the force sensing electrodes PE1, PE2. The force electrode layer 30 includes two force sensing electrodes PE1, PE2, and each of the touch sensing electrodes TE1-TE8, TEn is corresponding to at least one of the force sensing electrodes PE1, PE2. The “correspondence” means each of the touch sensing electrodes TE1-TE8, TEn is at least overlapped with one corresponding force sensing electrode PE1 or PE2 from projected view, or near the one corresponding force sensing electrode PE1 or PE2 from projected view, thus avoiding the influence due to warp of the resilient dielectric material layer 25. For example, the corresponding force sensing electrode for the selected touch sensing electrode TE4 is the force sensing electrode PE1. One touch sensing electrode may have plurality of corresponding force sensing electrodes if the area of the touch sensing electrode is larger than the area of the force sensing electrode. The above mentioned example is only for exemplary purpose and not for limitation of the present invention.

Refer to FIG. 5B, which is a schematic view showing signals applied in the touch sensing operation of the integral apparatus according to another embodiment of the present invention. The touch sensing integrated circuit 700 sequentially or randomly applies a first capacitance-exciting signal (also referred to as a touch capacitance-exciting signal) Vs to a selected touch sensing electrode, such as the touch sensing electrode TE4. Besides, the touch sensing integrated circuit 700 applies a reflection signal Vr having the same phase as that of the first capacitance-exciting signal Vs to non-selected touch sensing electrodes near the selected first touch sensing electrode TE4, for example touch sensing electrodes TE3, TE5 such that sensing electric lines are focused on the selected first touch sensing electrode TE4, thus enhancing sensitivity and accuracy of touch sensing for the selected first touch sensing electrode TE4. Although not explicitly shown in FIG. 5B, the touch sensing integrated circuit 700 transmits the first capacitance-exciting signal Vs, the auxiliary signal Va, and the reflection signal Vr through the plurality of switch circuits 580a, 580b in the force sensing integrated circuit 500 and receives the touch sensing signal Vc1 generated from the selected touch sensing electrode TE4. With reference also to FIG. 3, the auxiliary signal Va can be also applied to the force sensing electrode by the force sensing integrated circuit 500 in FIG. 5A and FIG. 5B.

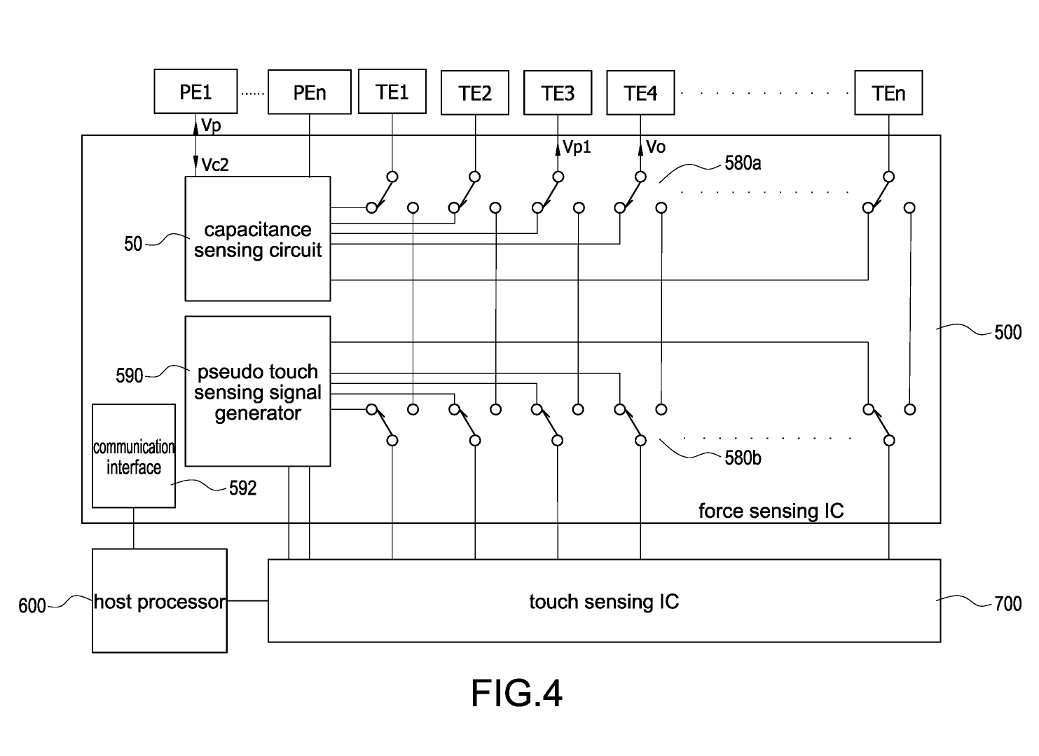

Refer to FIG. 4, which shows a schematic view of the integral apparatus for use in a force sensing operation according to the present invention. In the force sensing operation, the touch sensing electrodes TE1-TEn are electrically connected to the force sensing integrated circuit 500 through the switch circuits 580a in the force sensing integrated circuit 500 to conduct a force sensing operation. In addition, the force sensing integrated circuit 500 outputs a plurality of control signals to the touch sensing integrated circuit 700 in the force sensing operation, thereby interrupting or suspending the touch sensing operation of the touch sensing integrated circuit 700. Alternatively, a pseudo touch sensing signal generator 590 of the force sensing integrated circuit 500 outputs a plurality of pseudo touch sensing signals to the touch sensing integrated circuit 700 in the force sensing operation.

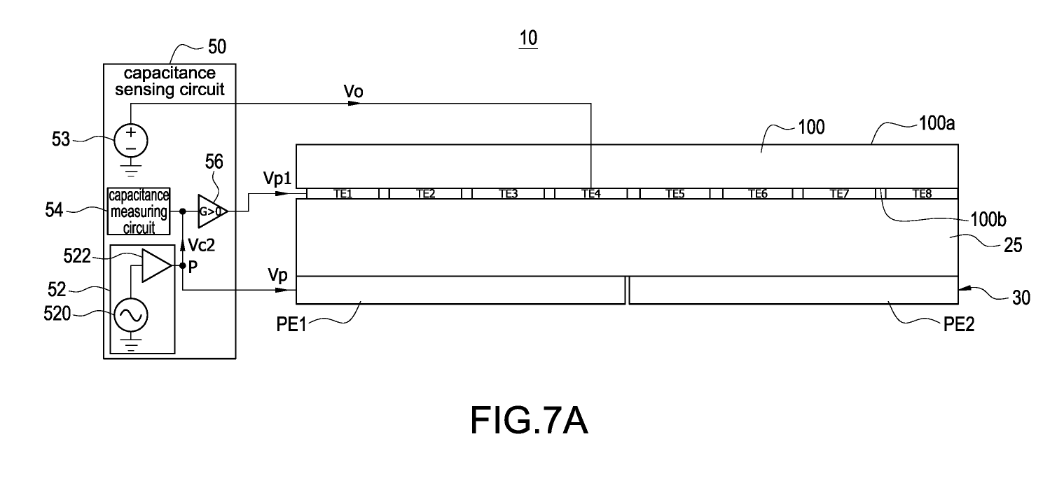

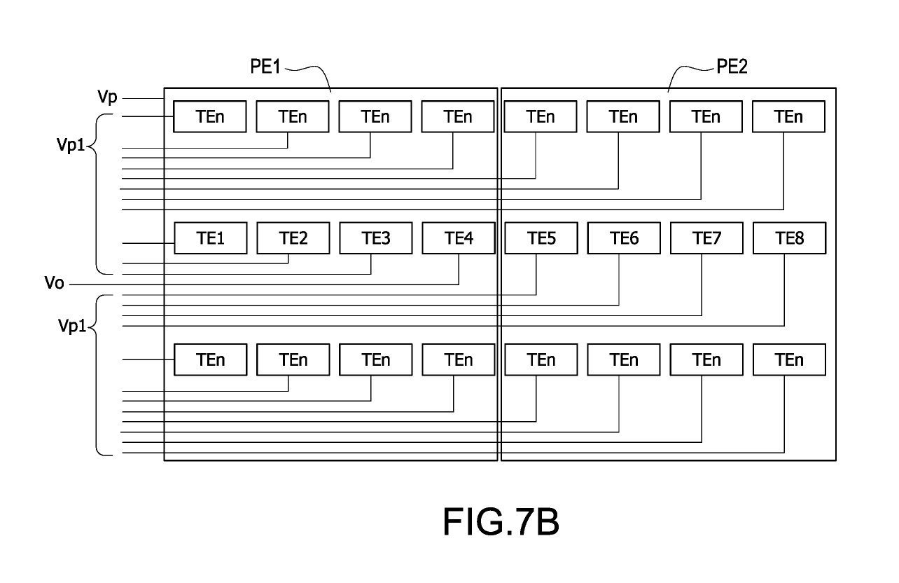

Refer to FIG. 7A and FIG. 7B, which are schematic views showing signals applied in the force sensing operation of the integral apparatus according to the present invention. The force sensing operation of the integral apparatus 10 may be immediately performed after the touch sensing operation described in FIG. 3 and FIG. 5A. For example, after the touch sensing operation of the selected touch sensing electrode TE4 is completed, the force sensing operation of the force sensing electrodes corresponding to the selected touch sensing electrode TE4, such as the force sensing electrode PE1 shown in FIG. 6 or all force sensing electrodes is performed. With reference also to FIG. 6, the capacitance sensing circuit 50 of the force sensing integrated circuit 500 applies a second capacitance-exciting signal Vp, namely a force capacitance-exciting signal to the force sensing electrode PE1 for sensing force since the selected touch sensing electrode TE4 is corresponding to the force sensing electrode PE1. The capacitance sensing circuit 50 has a non-inverting amplifier 56, and preferably a gain of the non-inverting amplifier 56 is one. The non-inverting amplifier 56 amplifies the second capacitance-exciting signal Vp to generate a shielding signal Vp1 having the same phase as that of the second capacitance-exciting signal Vp. The shielding signal Vp1 is applied to the non-selected touch sensing electrodes TE1-TE3, TE5-TE9, TEn, namely at least part of the selected touch sensing electrode TE4. Moreover, the capacitance sensing circuit 50 of the integral apparatus 10 provides a DC reference signal source 53, and the DC reference signal source 53 generates a counter-exciting signal Vo. The capacitance sensing circuit 50 sequentially or randomly applies the counter-exciting signal Vo to the selected touch sensing electrode TE4. With reference also to FIG. 7B, this figure shows a partial top view of the integral apparatus 10, which mainly depicts the distribution of the touch sensing electrodes TE1-TE8, TEn and the force sensing electrodes PE1, PE2 as well as the application manner of the second capacitance-exciting signal Vp, the shielding signal Vp1, and the counter-exciting signal Vo. With reference also to FIG. 7A, in the force sensing operation, the shielding signal Vp1 having the same phase as that of the second capacitance-exciting signal Vp is applied to the non-selected touch sensing electrodes, such as at least part of touch sensing electrodes other than the selected touch sensing electrode TE4 to shield the influence from user's finger and enhance accuracy of force sensing for the selected touch sensing electrode TE4. Moreover, the counter-exciting signal Vo with a predetermined voltage level is applied to the selected touch sensing electrode TE4 to enhance sensitivity of force sensing for the force sensing electrode PE1 corresponding to the selected touch sensing electrode TE4. The capacitance measuring circuit 54 of the capacitance sensing circuit 50 senses the force sensing signal Vc2 from the force sensing electrode PE1 at a sensing point P, thus precisely determining whether a pressing action is present and the amount of pressing force.

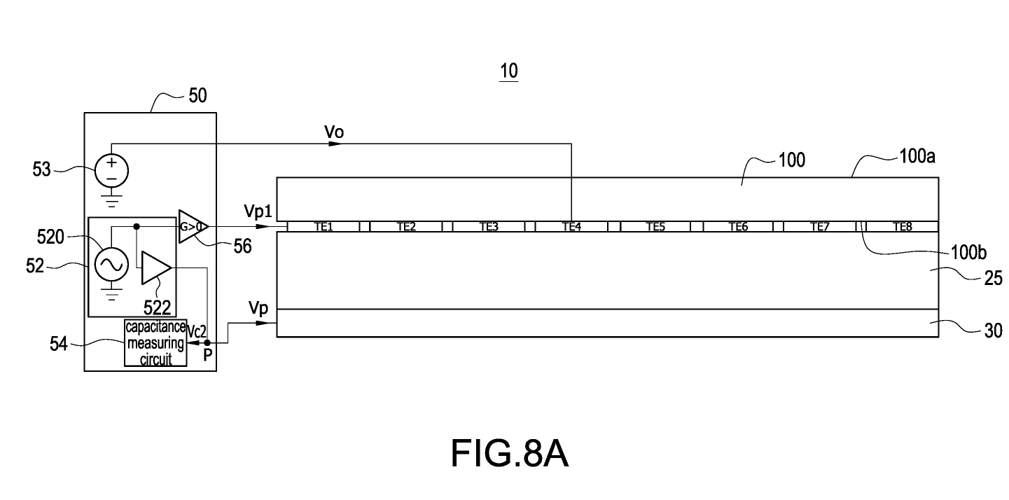

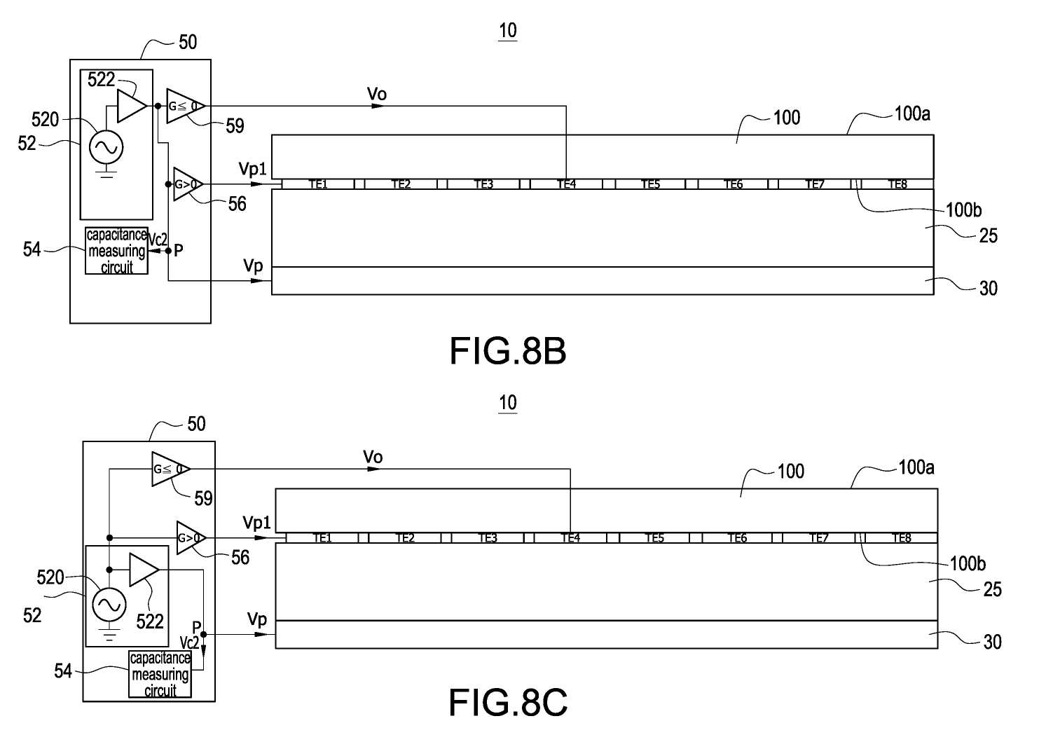

Refer to FIG. 8A, FIG. 8B, and FIG. 8C, which are schematic views showing signals applied in the force sensing operation of the integral apparatus according to different embodiments of the present invention. The embodiment in FIG. 8A is similar to that shown in FIG. 7A. However, in this embodiment, the input of the non-inverting amplifier 56 of the capacitance sensing circuit 50 for generating the shielding signal Vp1 is not connected to the input of the capacitance measuring circuit 54 (for example, the input of the non-inverting amplifier 56 is directly connected to the signal source 520) to prevent the influence from the force sensing signal Vc2 at the sensing point P of the capacitance measuring circuit 54. The embodiment in FIG. 8B is similar to that shown in FIG. 7A. However, the integral apparatus 10 uses an inverting amplifier 59 to generate a counter-exciting signal Vo with phase opposite to that of the second capacitance-exciting signal Vp for enhancing sensitivity and accuracy of force sensing for the force sensing electrode PE1. The embodiment in FIG. 8C is similar to that shown in FIG. 8A. Also, the integral apparatus 10 uses the inverting amplifier 59 to generate a counter-exciting signal Vo with phase opposite to that of the second capacitance-exciting signal Vp for preventing the influence from the force sensing signal Vc2 at the sensing point P of the capacitance measuring circuit 54 and enhancing sensitivity and accuracy of force sensing for the force sensing electrode PE1.

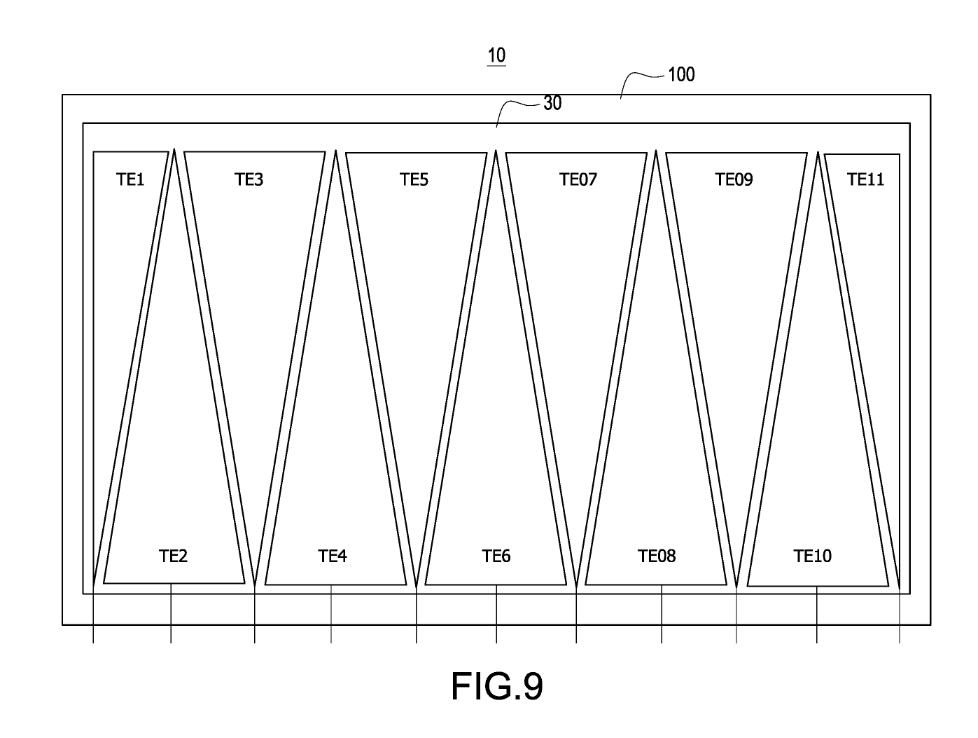

Refer to FIG. 9, which shows a partial top view of touch sensing electrodes of the integral apparatus according to another embodiment of the present invention. Compared with the embodiment in FIG. 6, the touch sensing electrodes TE1-TE11 may be triangular electrodes arranged in a separated manner, for example but not limited to isosceles triangular electrodes or right-angle triangular electrodes.

Moreover, in above embodiments, the first capacitance-exciting signal Vs (namely, the touch capacitance-exciting signal) and the second capacitance-exciting signal Vp (namely, the force capacitance-exciting signal) may be alternating signals such as sinusoid wave signals, square wave signals, triangular wave signals, or trapezoid wave signals. The first capacitance-exciting signal Vs or the second capacitance-exciting signal Vp may be a current source. The counter-exciting signal Vo may be a DC reference signal (for example a zero volt signal) or an alternating signal with phase opposite to that of the second capacitance-exciting signal Vp.

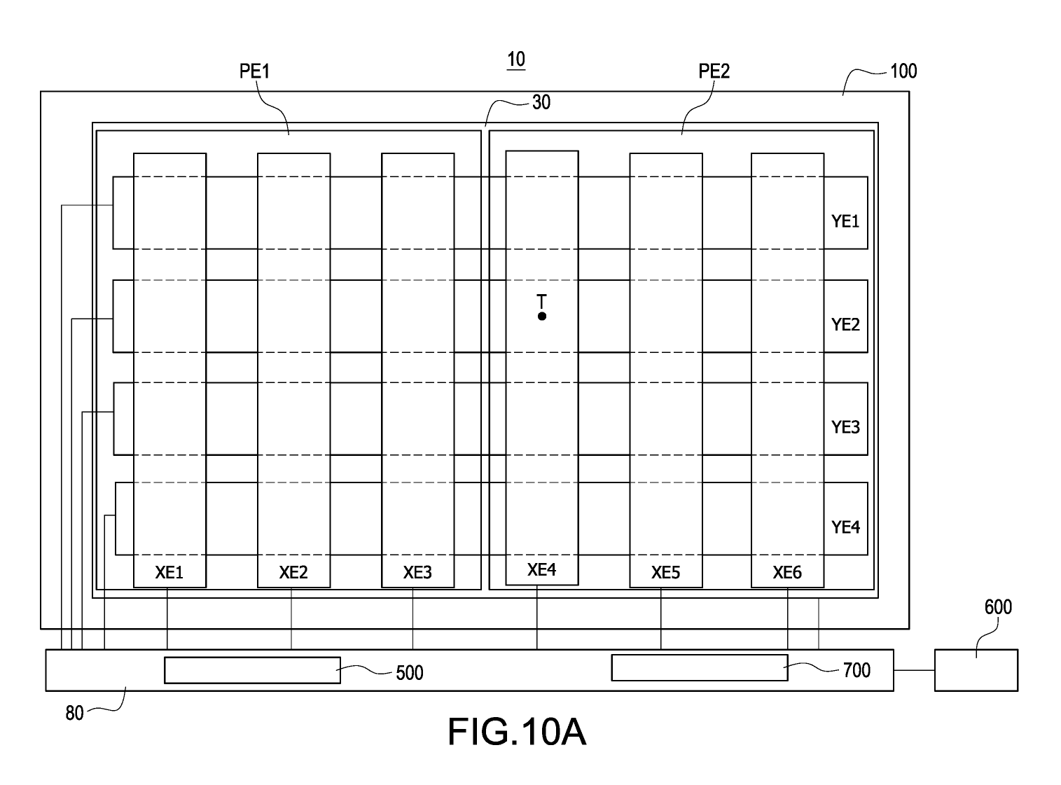

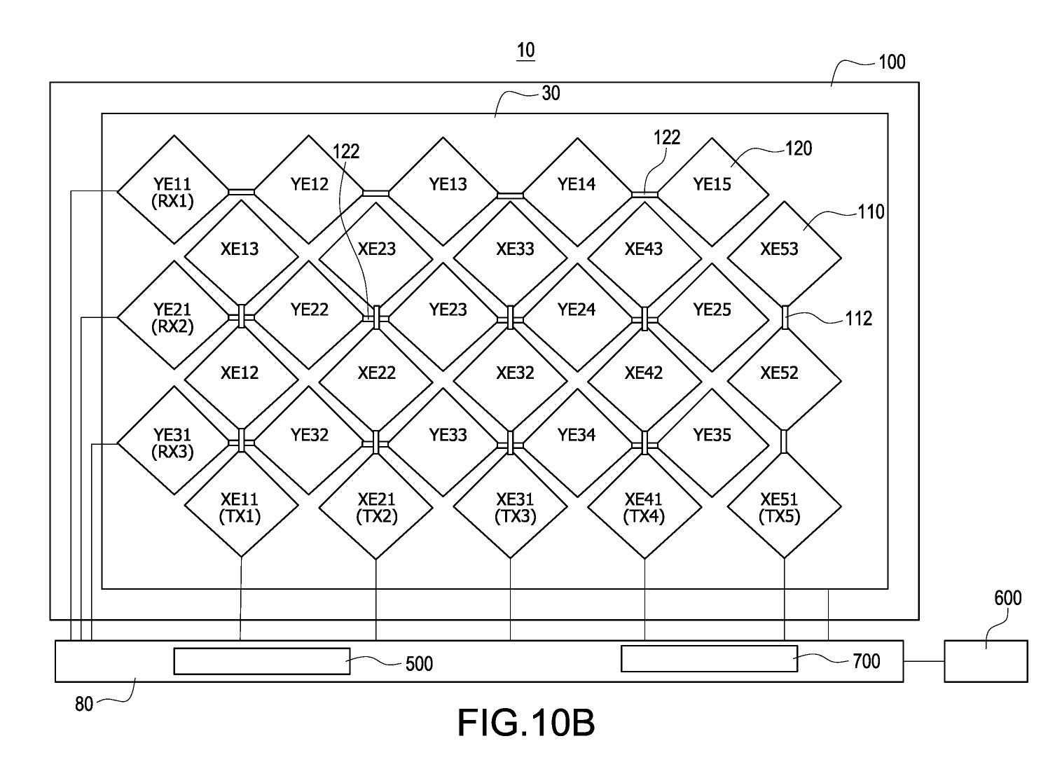

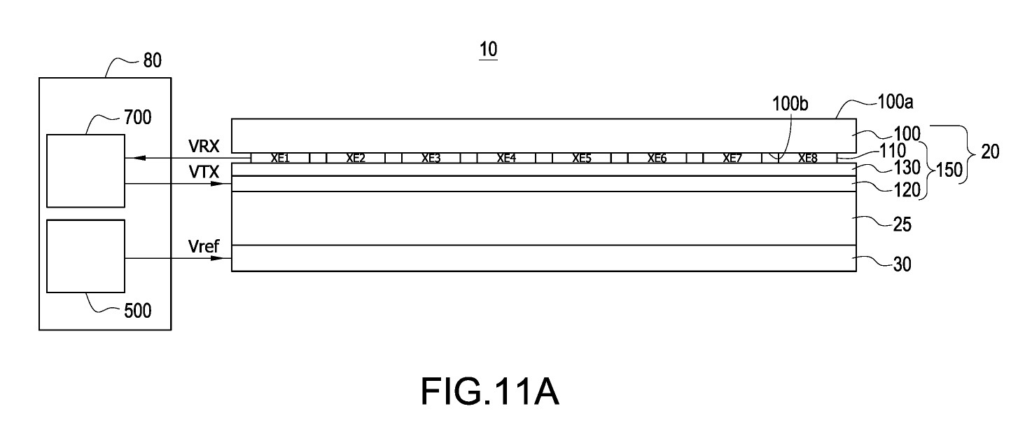

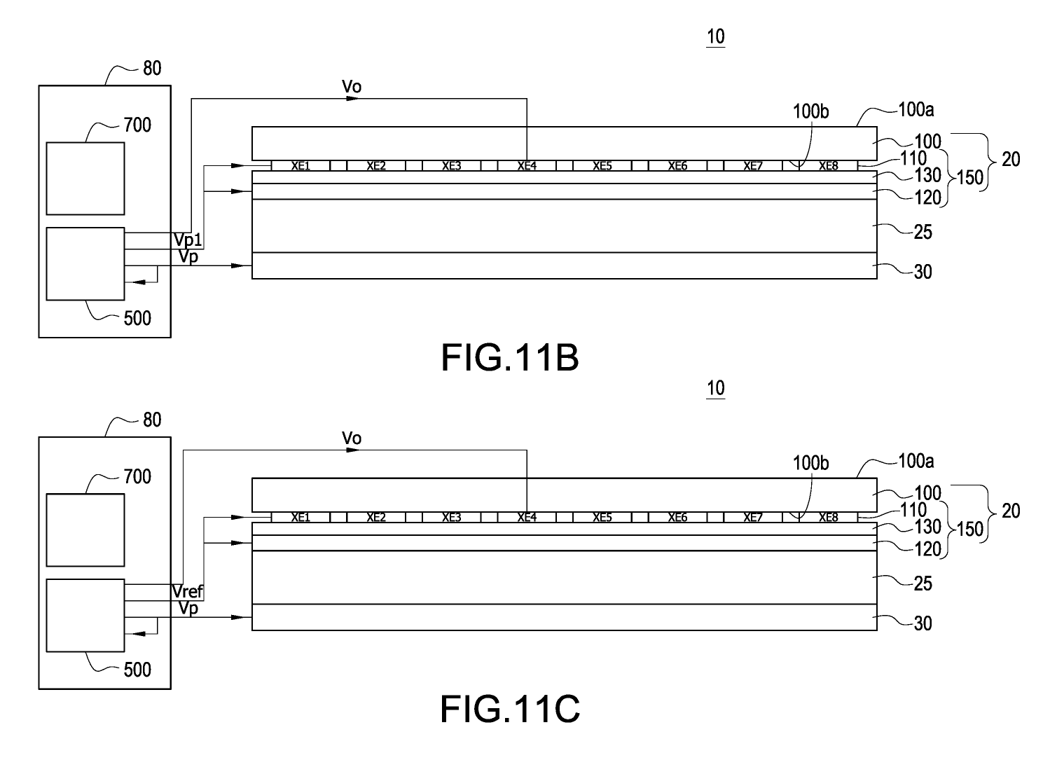

Refer to FIG. 10A, which shows a top view of the integral apparatus according to the present invention, which mainly depicts that the touch-control panel 20 is a mutual-capacitance touch-control panel. With reference also to FIG. 11A, the integral apparatus 10 includes, from top to bottom, a touch-control panel 20, a resilient dielectric material layer 25, and a force electrode layer 30. The touch-control panel 20 includes, from top to bottom, an upper substrate 100 with a first surface 100a and a second surface 100b and a mutual-capacitance touch sensing electrode layer 150. The mutual-capacitance touch sensing electrode layer 150 includes a plurality of first touch sensing electrodes 110 (such as touch sensing electrodes XE1-XE8 shown in FIG. 11A) extended along a first direction, a plurality of second touch sensing electrodes 120 extended along a second direction, and an insulation layer 130, where the first direction is different with the second direction and may be substantially perpendicular to the second direction. It should be noted that FIG. 11A only shows a stack diagram, the arrangement and distribution of the first touch sensing electrodes 110 and the second touch sensing electrodes 120 can be varied. The first touch sensing electrodes 110 are arranged on the second surface 100b of the upper substrate 100 and the second touch sensing electrodes 120 are arranged on a side of the insulation layer 130 opposite to the upper substrate 100. The first touch sensing electrodes 110 and the second touch sensing electrodes 120 sandwich the insulation layer 130 therebetween, and the first touch sensing electrodes 110 may electrically connect to other elements (such as a capacitance sensing circuit 50 described later) of the integral apparatus 10 by connection wire passing through the insulation layer 130. The force electrode layer 30 is arranged on a side of the mutual-capacitance touch sensing electrode layer 150 opposite to the upper substrate 100.

With reference also to FIG. 10A, the figure mainly depicts the distribution of the upper substrate 100, the first touch sensing electrodes 110, the second touch sensing electrodes 120, and the force electrode layer 30 (including the force sensing electrodes PE1, PE2) from top view. It should be noted that part of the electrodes are purposely separated with each other to clearly show individual feature/location. The scales of the first touch sensing electrodes 110, the second touch sensing electrodes 120, and the force electrode layer 30 are not limited by this figure. The integral apparatus 10 further includes a touch sensing integrated circuit 700 and a force sensing integrated circuit 500 arranged on the flexible printed circuit board 80. The force sensing integrated circuit 500 includes a capacitance sensing circuit such as a self-capacitance sensing circuit (not shown). In this embodiment, the first touch sensing electrodes 110 (such as the first touch sensing electrodes XE1-XE6 in this figure) extend along a first direction, the second touch sensing electrodes 120 (such as the second touch sensing electrodes YE1-YE4 in this figure) extend along a second direction where the first direction is different with the second direction and may be substantially perpendicular to the second direction. It should be noted FIG. 10A only shows a top view, the arrangement and distribution of the first touch sensing electrodes 110 and the second touch sensing electrodes 120 can be varied. The integral apparatus 10 further electrically connects to a host processor 600 for receiving commands transmitted from the host processor 600 or transmitting sensing results of touch/force sensing operations to the host processor for further processing.

Refer to FIG. 11A, which shows a schematic view of the integral apparatus 10 shown in FIG. 10A in a touch sensing operation. The first touch sensing electrodes 110 are used as touch sensing electrodes to detect whether user's finger touches the integral apparatus 10 and the second touch sensing electrodes 120 are used as touch driving electrodes. The touch sensing integrated circuit 700 first selects one or more first touch sensing electrodes 110 and one or more second touch sensing electrodes 120 for touch sensing. In below description, multiple first touch sensing electrodes 110 and second touch sensing electrodes 120 are used for demonstration, it should be noted this application can also be applied to touch sensing with one first touch sensing electrode 110 and one second touch sensing electrode 120. In the touch sensing operation, the touch sensing integrated circuit 700 is electrically connected to the selected first touch sensing electrodes 110 and the selected second touch sensing electrodes 120 through the switch circuits 580a, 580b of the force sensing integrated circuit 500 shown in FIG. 3 and/or FIG. 4. The touch sensing integrated circuit 700 sequentially or randomly applies a touch driving signal VTX to the selected second touch sensing electrodes 120 and sequentially or randomly receives (senses) a touch sensing signal VRX from the selected first touch sensing electrodes 110, the force sensing integrated circuit 500 also applies a DC reference voltage Vref (such as a zero volt voltage) to the at least one force sensing electrode (such as the force sensing electrode PE2 shown in FIG. 10A) to decrease or eliminate the measurement influence due to warp or deformation of the resilient dielectric material layer 25. By sensing the touch sensing signal VRX, the integral apparatus 10 can identify whether a touch event occurs at a location corresponding to an intersection of the first touch sensing electrode 110 and the second touch sensing electrode 120. With reference to FIG. 10A, by applying the touch driving signal VTX to the second touch sensing electrode YE2 and sensing the touch sensing signal VRX from the first touch sensing electrode XE4, the integral apparatus 10 can identify whether a touch event occurs at a touch point T corresponding to an intersection of the second touch sensing electrode YE2 and the first touch sensing electrode XE4. Moreover, the DC reference voltage Vref is also provided by the force sensing integrated circuit 500 shown in FIG. 11A.

Refer to FIG. 11B, which shows a schematic view of the integral apparatus 10 shown in FIG. 10A in a force sensing operation. In this embodiment, the force sensing operation is performed after the touch sensing operation shown in FIG. 11A. With reference to FIG. 10A, the force sensing integrated circuit 500 (for example including a self-capacitance sensing circuit) applies a second capacitance-exciting signal Vp to the force sensing electrode PE2 corresponding to the selected first touch sensing electrode. The force sensing integrated circuit 500 further applies, sequentially or randomly, the counter-exciting signal Vo to the selected first touch sensing electrode(s) (such as the first touch sensing electrode XE4). Moreover, the force sensing integrated circuit 500 may further apply the counter-exciting signal Vo, at the same time (or sequentially or randomly) as applying to the selected second touch sensing electrode(s) (such as the second touch sensing electrode YE2). The force sensing integrated circuit 500 may apply the shielding signal Vp1 to the non-selected first touch sensing electrodes XE1-XE3, XE5-XE8 (or at least part of the first touch sensing electrodes near the selected first touch sensing electrode XE4) to shield the influence from user's finger; and/or the force sensing integrated circuit 500 may apply the shielding signal Vp1 to the non-selected second touch sensing electrodes 120 (such as the second touch sensing electrodes YE1, YE3, and YE4) to shield the influence from user's finger. In above embodiments, the second capacitance-exciting signal Vp may be a time varying (alternating) signal such as sinusoid wave signal, square wave signal, triangular wave signal, or trapezoid wave signal. Moreover, the second capacitance-exciting signal Vp may be a current source. The counter-exciting signal Vo is a DC reference signal (such as a zero volt signal) or an alternating signal with phase opposite to that of the second capacitance-exciting signal Vp. The shielding signal Vp1 is a signal with the same phase as that of the second capacitance-exciting signal Vp.

Refer to FIG. 11C, which shows a schematic view of the integral apparatus 10 shown in FIG. 10A in a force sensing operation according to another embodiment of the present invention. The embodiment shown in FIG. 10C is similar to that shown in FIG. 10B. In the force sensing operation, the capacitance sensing circuit 50 applies a DC reference voltage Vref to the non-selected first touch sensing electrodes XE1-XE3, XE5-XE8 (or at least part of the first touch sensing electrodes near the selected first touch sensing electrode XE4) to shield the influence from user's finger; and/or the capacitance sensing circuit 50 may apply the DC reference voltage Vref to the non-selected second touch sensing electrodes 120 (such as the second touch sensing electrodes YE1, YE3, and YE4) to shield the influence from user's finger. The DC reference voltage Vref may be a zero volt voltage.

With reference also to FIG. 10B, this figure shows a top view of the integral apparatus 10 according to another embodiment of the present invention. The touch-control panel 20 of the integral apparatus 10 is a mutual-capacitance touch-control panel. The first touch sensing electrodes 110 extend along a first direction. The first touch sensing electrodes 110 include, for example, five columns (TX1-TX5) of first touch sensing electrodes XE11-XE13, XE21-XE23, XE31-XE33, XE41-XE43, and XE51-XE53, and the first touch sensing electrodes in the same column are connected to each other by conductive bridges 112. The second touch sensing electrodes 120 extend along a second direction. The second touch sensing electrodes 120 include, for example, three rows (RX1-RX3) of second touch sensing electrodes YE11-YE15, YE21-YE25, and YE31-YE35, and the second touch sensing electrodes in the same row are connected to each other by conductive bridges 122. The first touch sensing electrodes 110 and the second touch sensing electrodes 120 are coplanar with each other. The first direction is different with the second direction and may be substantially perpendicular to the second direction. Moreover, insulation layers (not shown) are provided between the conductive bridges 112 and the conductive bridges 122 to prevent short circuit therebetween. The conductive bridges 112 and the conductive bridges 122 may be made with transparent conductive material such as Indium Tin oxide (ITO).

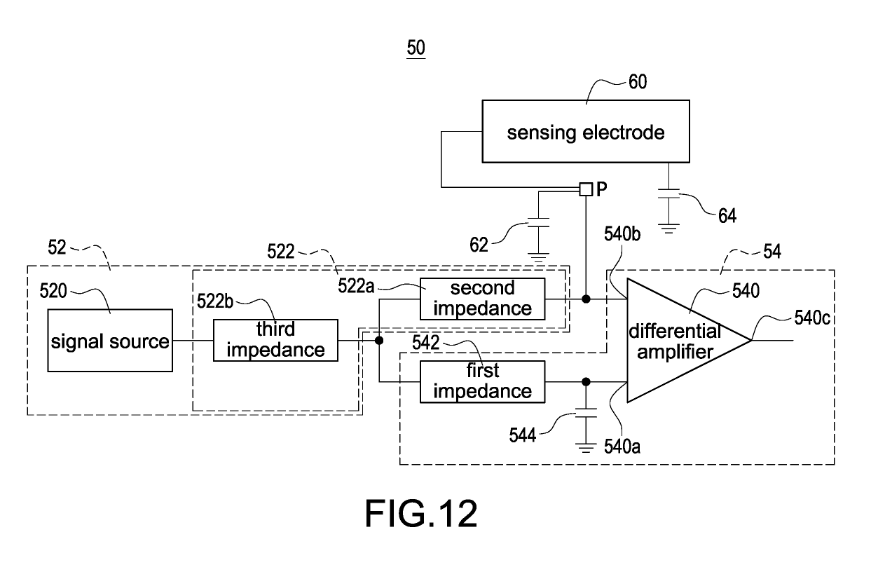

Refer to FIG. 12, which shows a circuit diagram of a self-capacitance sensing circuit according to the present invention. The capacitance sensing circuit 50 may be a self-capacitance sensing circuit. The capacitance sensing circuit 50 mainly comprises a capacitance-excitation driving circuit 52 and a capacitance measuring circuit 54 to sense a capacitance change at a sensing point P. The capacitance-excitation driving circuit 52 includes a signal source 520 and a driving unit 522 (including a second impedance 522a and a third impedance 522b). The capacitance measuring circuit 54 includes a differential amplifier 540, a first impedance 542, and a first capacitor 544 and is used to sense a capacitance change at a sensing electrode 60, where the sensing electrode 60 has a first stray capacitance 62 and a second stray capacitance 64.

The signal source 520 is electrically coupled to the first impedance 542 and the second impedance 522a. The first impedance 542 is electrically coupled to the first capacitor 544 and the first capacitor 544 is electrically coupled to the first input end 540a of the differential amplifier 540. The second impedance 522a is electrically coupled to the second input end 540b of the differential amplifier 540. The sensing electrode 60 is electrically coupled to the second impedance 522a and the second input end 540b through a node (such as an IC pin) of the capacitance sensing circuit 50. The first stray capacitance 62 is electrically coupled to the node and the second stray capacitance 64 is electrically coupled to the sensing electrode 60.

In the capacitance sensing circuit 50 shown in FIG. 12, the sensing electrode 60 receives a touch signal when a finger or a conductor is touched thereon. The signal source 520 is a periodical signal and sent to the third impedance 522b, while the resistance values of the first impedance 542 and the second impedance 522a are identical. The differential amplifier 540 will generate a differential touch signal after receiving the signal source 520 and the touch signal from the sensing electrode 60. In this embodiment, the capacitance of the first capacitor 544 is equal to the resulting capacitance of the first stray capacitance 62 in parallel connection with the second stray capacitance 64. The capacitance of the second stray capacitance 64 changes when user's finger approaches or touches the sensing electrode 60. Therefore, the voltages fed to the first input end 540a and the second input end 540b will be different such that the differential amplifier 540 has a (non-zero) differential output at the output end 540c. In this way, the minute capacitance change on the sensing electrode 60 can be detected by the differential amplifier 540. Moreover, the noise from circuits or power source can be advantageously removed. The detail of the capacitance sensing circuit 50, namely the self-capacitance sensing circuit can be referred to U.S. Pat. No. 8,704,539 filed by the same applicant.

Moreover, in above embodiments, the upper substrate 100 is a glass substrate, a polymer thin film substrate, or a cured coating layer to protect the touch sensing electrodes on the touch sensing electrode layer from damage due to scratch, collision, or moisture. The resilient dielectric material layer 25 includes a resilient gelatinous material, the resilient gelatinous material is compressively deformed under pressure and restores to original shape and volume if pressure is not present. The resilient gelatinous material is, for example but not limited to, polydimethylsiloxane (PDMS), or optical clear adhesive (OCA). As mentioned above, the resilient dielectric material layer 25 is arranged between the touch-control panel 20 and the force electrode layer 30. Besides, the resilient dielectric material layer 25 is arranged on one side of the resilient dielectric material layer 25 is arranged between the touch-control panel 20 and the force electrode layer 30 opposite to the touch-control panel 20. The force electrode layer 30 may be an electrostatic protection layer, common voltage layer, cathode layer of a display screen, or a polarizer layer formed by a conductive material of a display screen.

Although the present invention has been described with reference to the preferred embodiment thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. An integral apparatus for sensing touch and force, the integral apparatus comprising:
a touch-control panel having a plurality of touch sensing electrodes, a plurality of conductive pads, and a plurality of electrode connecting wires;
a force electrode layer having at least one force sensing electrode;
a resilient dielectric material layer arranged on one side of the force electrode layer;
a flexible printed circuit board electrically connected to the touch-control panel and the force electrode layer;
a touch sensing integrated circuit arranged on the flexible printed circuit board; and
a force sensing integrated circuit arranged on the flexible printed circuit board, and the force sensing integrated circuit having at least one capacitance sensing circuit and a plurality of switch circuits;
in a touch sensing operation, the touch sensing electrodes electrically connected to the touch sensing integrated circuit through the switch circuits in the force sensing integrated circuit to conduct the touch sensing operation;
in a force sensing operation, the touch sensing electrodes electrically connected to the at least one capacitance sensing circuit in the force sensing integrated circuit through the plurality of switch circuits in the force sensing integrated circuit to conduct the force sensing operation.

2. The integral apparatus in claim 1, wherein the capacitance sensing circuit is a self-capacitance sensing circuit.

3. The integral apparatus in claim 1, wherein the force sensing integrated circuit is configured to output a plurality of pseudo touch sensing signals to the touch sensing integrated circuit in the force sensing operation.

4. The integral apparatus in claim 1, wherein the force sensing integrated circuit is configured to output a plurality of control signals to the touch sensing integrated circuit in the force sensing operation, thereby interrupting or suspending the touch sensing operation of the touch sensing integrated circuit.

5. The integral apparatus in claim 1, wherein the capacitance sensing circuit is configured to apply a force capacitance-exciting signal to the at least one force sensing electrode and sense a force sensing signal from the at least one force sensing electrode in the force sensing operation.

6. The integral apparatus in claim 5, wherein the force capacitance-exciting signal is an alternating signal or a current source.

7. The integral apparatus in claim 5, wherein the capacitance sensing circuit is configured to sequentially or randomly apply a counter-exciting signal to a selected touch sensing electrode.

8. The integral apparatus in claim 7, wherein the counter-exciting signal is a DC reference signal or an alternating signal with phase opposite to phase of the force capacitance-exciting signal.

9. The integral apparatus in claim 8, wherein the DC reference signal is a zero volt signal.

10. The integral apparatus in claim 7, wherein the capacitance sensing circuit is configured to apply a reflection signal having the same phase as that of the force capacitance-exciting signal to non-selected touch sensing electrodes in the force sensing operation.

11. The integral apparatus in claim 1, wherein the force electrode layer is an electrostatic protection layer of a display screen.

12. The integral apparatus in claim 1, wherein the force electrode layer is a polarizing layer formed by a conductive material of a display screen.
